(19) United States
(12) Patent Application Publication
(10) Pub. No.: US 2011/0279269 A1
(43) Pub. Date: Nov. 17, 2011

(54) Countdown timer application and method for programmable personal digital devices

(76) Inventor: Jeremy Gerber, Binyamina (IL)

(21) Appl. No.: 13/101,160

(22) Filed: May 5, 2011

Related U.S. Application Data
(60) Provisional application No. 61/345,126, filed on May 16, 2010.

(51) Int. Cl. G06F 1/14; G08B 21/00; H04N 5/225

(52) U.S. Cl. 340/540; 713/502; 348/231.5; 348/E05.024

(57) ABSTRACT

A countdown timer application (computer program) that runs on programmable personal digital devices (“devices”) such as smartphones, tablet computers, and mobile Internet devices. The application is able to run several timers at once with different end times, the same end time and different beginning times, and one timer after another such that the end of one countdown triggers the beginning of another. Timers can repeat, such that when timer reaches zero it alerts user and begins to count down again indefinitely.

A plurality of methods of alerting the user that the timer has reached zero are speaking a recording; displaying a photo or a video, playing music, and displaying text.

Further, timers can be triggered based on awareness of the device's various sensors' states.

Further, a version of the application uses synchronized devices, wherein the acknowledgment or non-acknowledgment of an alert on one device triggers notification on another device.

### RELATED APPLICATION

This application is based upon application No. 61/345,126 (provisional) filed May 16, 2010.

### FIELD OF THE INVENTION

The present invention relates to computer software and more especially to a software application that is downloaded to a personal digital device and installs one, or more, user controlled timers on the device.

### BACKGROUND OF THE INVENTION

At the present time personal digital devices (“devices”) are becoming increasingly popular. These devices are portable, hand-held, and battery operated. They include a digital display screen, a built-in microphone, a built-in keyboard (either actual or virtual), and are controlled by digital software programs. Such devices include smartphones, e-readers, tablet computers, and mobile internet devices including the “iPad” (™ Apple Computer).

The present invention, using this software application, permits the user to program one, or more, timers to count down to zero. At zero the device will provide an “alert”—which may be a text message on the device's screen, broadcast the user's own voice message (not a computer generated voice), or music, or show a video or photo on the device's screen. This permits a user to set up a schedule as to when to perform an action, for example to take a medicine or perform steps in cooking.

At the present time many timers are available such as separate electric and mechanical kitchen timers, as well as timers on microwave and other stoves. The U.S. Patent prior art includes the following patents:
1. U.S. Pat. No. 5,960,440 to Brenner et al. discloses a kitchen device that displays cooking time of a recipe and sets a timer for that time.
2. U.S. Pat. No. 6,998,961 to Stihler discloses an alarm device which records a user's voice and projects the recorded sound as an alarm.
3. Application 20090140855 to Shemesh et al. discloses a number of devices including a timer of a personal device which outputs a computer generated voice message as a reminder.

### SUMMARY OF THE INVENTION

A countdown timer application (software computer program) runs on programmable personal digital devices (“devices”) such as smartphones, tablet computers, e-readers, and mobile internet devices. The term “personal digital device” means a hand held device which is battery operated, portable, has a digital display screen, has computer memory, and is controlled by digital software programs. It generally has a camera, a speaker, and a microphone.

The application runs several timers at once with different end times, several timers at once with the same end time but different beginning times, and one timer after another (the end of one countdown triggers the beginning of another). The application runs repeating timers. When a timer reaches zero it alerts the user and also can be configured to begin to count down again, with indefinite repetition.

The application has various methods of alerting the users that the time has ended (timer has reached zero). Such alerting methods are broadcasting a message that the user has spoken into the device, displaying a picture (photo or video), playing music, displaying a text message, and sending a text message (SMS) to another party. For example, the user sets the timer at three minutes and the device announces a message recorded by the user when he sets the timer, i.e. “take eggs out of the boiling water”.

The application allows the user to create various types of alerts during setup of a given timer, beforehand (saved into the device's memory), or by downloading alerts, or pre-set timers complete with times and alerts, from an online Internet service.

The application may be set to share alerts via email. For example, a parent may set an alert that his/her child has a piano lesson on Tuesday at 3 pm. That alert, along with a picture of a piano and voice message saying “piano lesson” may be sent from the parent to the child by email. The child would then enter the alert onto the child's personal digital device. The child need only open his/her email and the application of the present invention, on the child's personal digital device, will automatically enter the alert on his/her personal digital device. When child clicks on the attachment, the application will automatically import the file and create the timer with whatever voice message, time, and photo was sent. The timer will be ready to go within the child's application. Child simply needs to click (or actually “press” or “select” on touch screen devices) the attachment, and the application will do the rest.

The application also provides a weekly alarm and a calendar alarm. The weekly alarm provides an alert, when set by the user, for one week. The calendar alarm provides an alert for as long as desired, for example for an entire year. For example, the weekly alarm may be set to provide an audio alert for 3 pm on Tuesday and Saturday one week in advance. The calendar alarm, for example may be set to provide an audio alert every Tuesday and Saturday, at 3 pm, for an entire year. The weekly alarm can be set to give alerts within a one week time frame, but they can repeat. For example, every Tuesday and Thursday at 3 pm. But the calendar alarm can be any time in the future, for example next January 15 at 3 pm and July 24 at 7 am, as well as repeating next October 12 at 1 pm for the next 3 years.

A timer or series of timers are triggered to start based on awareness of device's various sensors' states if the device has such sensors. For example, a device that has built in GPS (global positioning system) or A-GPS (assisted-global positioning system) could trigger a timer to count down when user visits the beach such that after half an hour timer tells user to apply more sun block.

An expanded version of the timer that works across several devices and a synchronizing server lets the acknowledgment of a timer alert, or lack of acknowledgment, to act as an alert from one device to another. For example, a timer tells a user to take his medicine and if that alert is unacknowledged a caregiver's device is alerted that the medicine was not taken.

### DESCRIPTION OF THE DRAWINGS

The enclosed drawings illustrate certain embodiments of the present invention. In the drawings:

FIG. 1 is a flow diagram of a general method and means for the software application of the present invention;

FIGS. 2, 3, and 4 are flow diagrams of specific embodiments of the method and means shown in FIG. 1;

FIG. 5 is a flow diagram in which the application is expanded to several devices and users to form a system in the healthcare field to improve compliance with taking medicines;

FIG. 6 is a flow diagram in which the application sends an alert or alerts via email to another personal digital device; and

FIG. 7 is a flow diagram in which the application sends an alert or alerts via bluetooth transmission to another personal digital device; and

FIG. 8 is a diagram in which the application is set for a weekly and a yearly series of alarm alerts.

### DETAILED DESCRIPTION

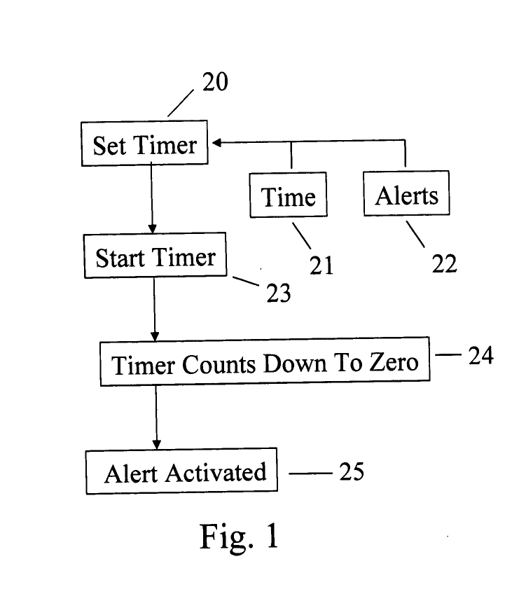

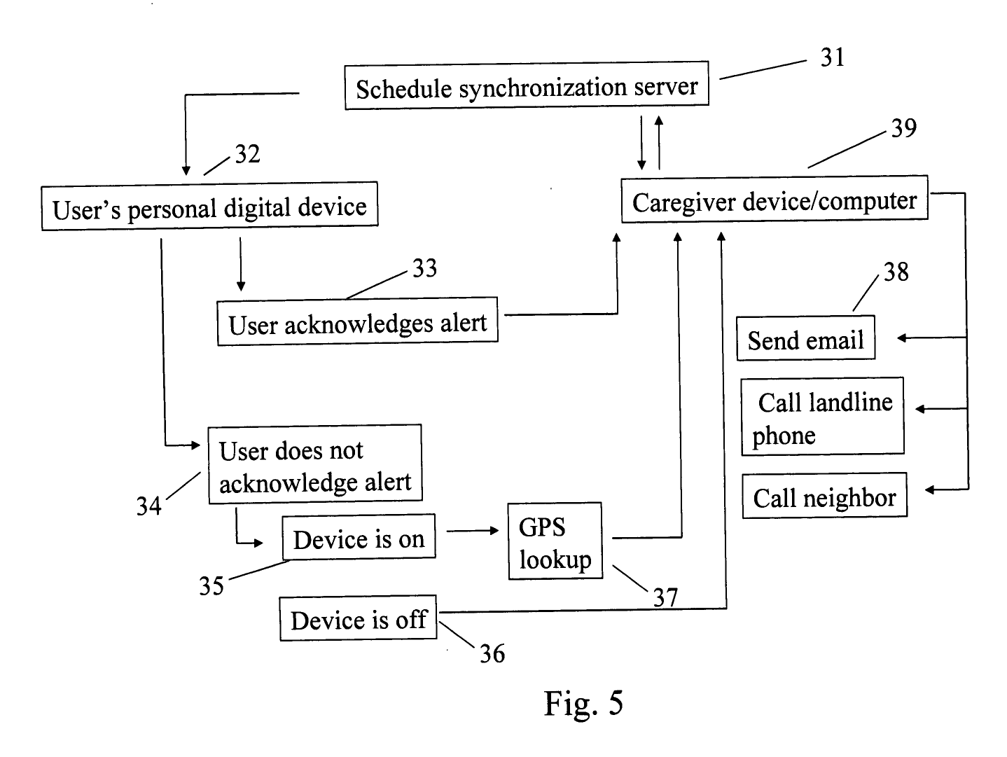

As shown in FIGS. 1-8 the “application” is installed on a personal digital device 1. Such a device 1, as defined herein, is a battery operated, hand-held, portable device having a digital display screen and is controlled by digital software programs. Examples of such personal digital devices are smartphones, tablet computers, e-readers, and mobile internet devices. FIG. 5 shows a flow diagram of the application working across several devices, computers, and the Internet in a healthcare environment to improve compliance with taking medicines.

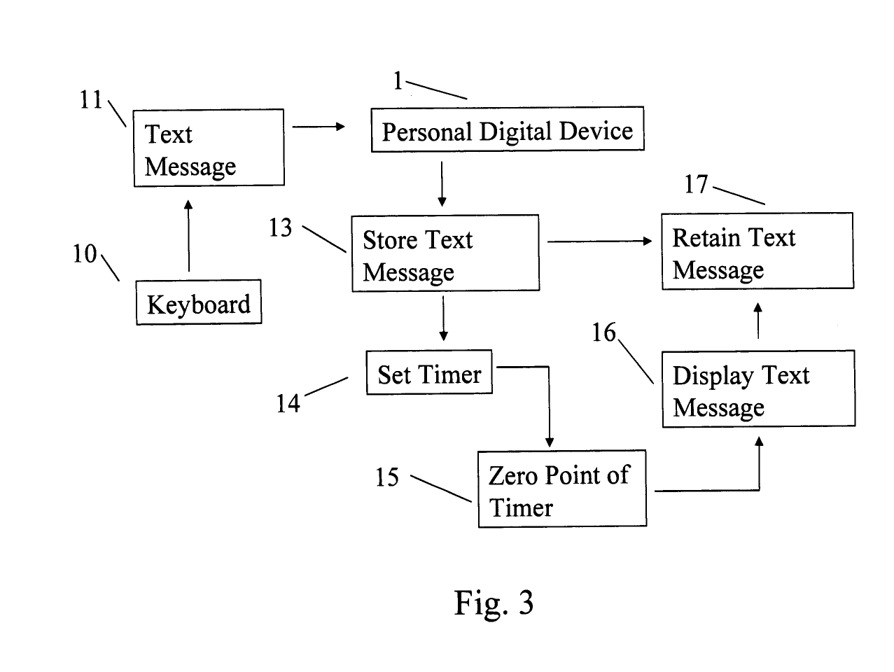

The digital device (“device”) has a keyboard 10 which may be an actual or a virtual (screen) keyboard which is finger operated to generate a text message 11, the device also has a microphone to input the user's voice 12 and circuitry to generate an audio file 13 from the user's voice. The device has digital memory which is used by the application in a number of ways. These uses of the device's memory include:
1. As a single timer and as a plurality of timers, for example three, to store the selected countdown time. The user sets a timer for the chosen number of seconds, minutes, or hours. The timer counts down to zero and generates an alert signal (to be described later).
2. The user sets the timer to a specific date and time to reach zero. For example, “Friday April 30 at 3:00 PM”. When the timer reaches zero it generates an alert signal at the selected date and time.
3. The user employs keyboard 10 to generate a text message 11 which is stored in the device memory i.e. store text message 13. In this embodiment, shown in FIG. 3, the user sets the timer “set timer” 14. At the “zero point of timer” 15 the device generates an alert signal. In the embodiment shown in FIG. 3 the alert signal is a display of the stored text message (“display text message 16”) on the screen of the device. Preferably, as shown in FIG. 3, the text message is not erased from storage after being displayed but rather is held in device storage (“retain text message” 17) for re-use.

A general flowsheet is shown in FIG. 1. The user downloads and installs the application in his device. To use it he sets one, or more timers, using the keyboard of the device (“set timer” 20). In the future, using voice recognition software and the microphone of the device, the timer or timers may be set by voice command.

The user sets the time 21 and the alert 22. For example the alert may be audio (music, bell, or voice) or visual (display of photo taken using the device or other stored photo on display). The user then starts the timer (“start timer” 23). When the timer counts down to zero 24 it generates an alert signal and the selected alert is activated (“alert activated” 25).

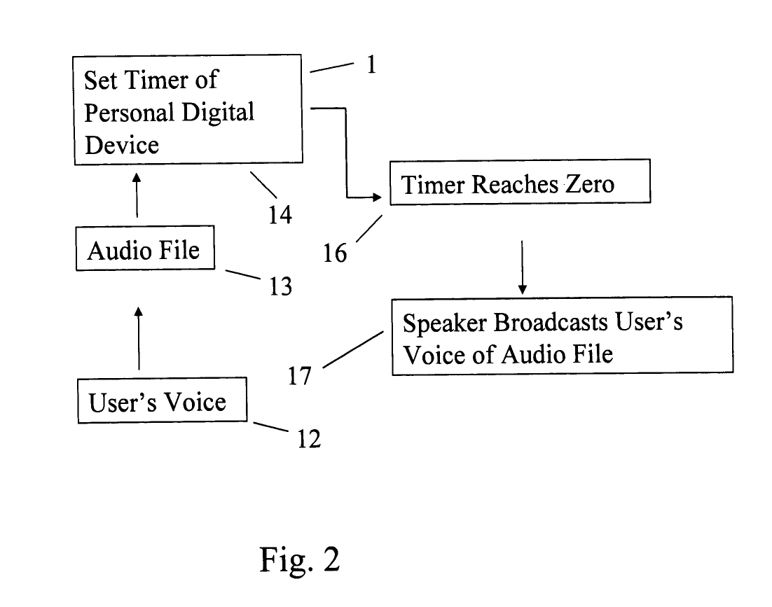

FIG. 2 illustrates a specific embodiment of the method of FIG. 1. In FIG. 2 the user records a voice message, such as “take the peas of the stove” for example with the user's voice 12. That message is spoken into the device 14 microphone and recorded in device memory as an audio file 13. The user sets the timer and when the timer reaches zero 16 it generates an alert signal. That alert signal causes the recorded voice message to be broadcast by the device (“speaker broadcasts user's voice of audio file” 17).

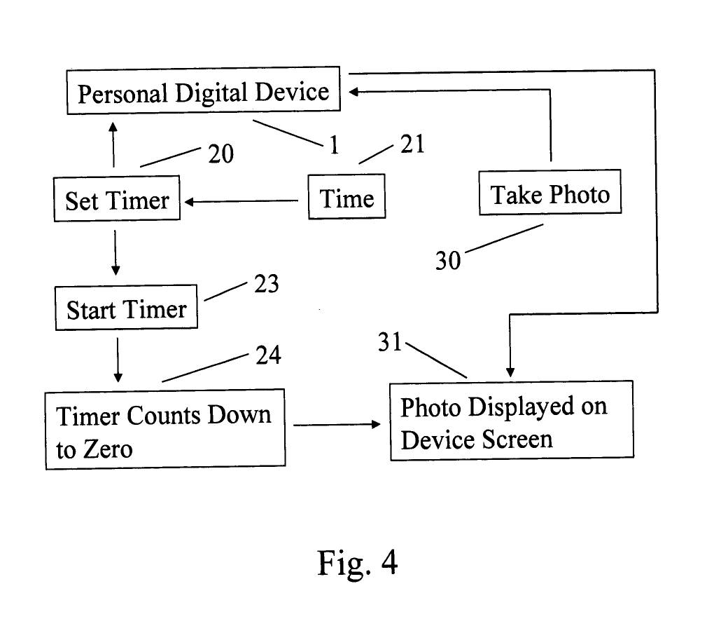

FIG. 4 illustrates a specific embodiment of the method of FIG. 1. In FIG. 4 the user takes a photograph using the device's built-in camera 30. That photograph is displayed on the device screen 31 for user's approval. The user sets the timer 20 and when the timer reaches zero 24 it generates an alert signal. That signal alert causes the photograph 31 to be displayed on the device.

The device is programmed to use one or a variety of alerts. The alerts which are generated by the user and which are retained in device memory include text messages entered from the device keyboard, voice or music entered from the device microphone, and photo and/or video entered from the device camera. In addition stock photos, video and/or music may be downloaded into device memory by logging the device onto the Internet. More alerts include actions that the device is programmed to take, including snapping a photo or video clip and emailing it or uploading it to an Internet site, sending an SMS text message, calling a phone number and speaking a pre-recorded message, mute/un-mute the device's speaker, record an audio clip, turn off the device, or launch another application.

The use of plural timers and date/time sets is especially useful to set a schedule of medicines. The voice message alert is, for example, “This is Tuesday at 3:00 PM, time to take your blood pressure pill.” The timers will be re-set automatically so the message (alerts) will be repeated each day, week, or month.

The timers are programmed as follows: (1) pre-set to run in parallel with varying start times and a common end (reach zero) time; (2) pre-set to run serially so that the end of one triggers the start of another and/or (3) the timers are set to repeat their timing alerts until re-set.

A timer may be set to begin its count down to zero by a trigger signal from a sensor built into the device. A sensor may be a thermometer, an accelerometer, or a location awareness sensor (GPS or AGPS).

The device microphone may be used as a sensor to detect noise level. In one embodiment a timer is set to trigger sending a text message (SMS) as an alert if certain conditions are met. For example, if device's microphone detects a high noise level over a period of time, thus triggering a count down, the device sends a text message to the user's employer stating that user has been in a high noise environment for a long time. Thus employer should take action to preserve his employee's hearing.

A text message (SMS) could also be sent to a caregiver in the example of a user who did not turn off his timer that had told him to take his medicine. Caregiver would be alerted that timer's alert was ignored (FIG. 5). A timer could be triggered, and a text message (SMS) sent to a caregiver upon reaching zero, if the device's accelerometer registers a sudden fall and vibration. The application would ask user if he fell and needs help, and user does not answer by the time the timer has counted to zero, the text message (SMS) alert would be sent.

A timer's alert can be turned off by voice command or by shaking the device, but preferably it is turned off by pushing a button, for example a button labeled “off” on the touch sensitive screen of a mobile phone.

The timers' zero point is retained in the device's memory even when device is turned off, such that when device is restarted, any timers that would have reached zero when the phone was off will trigger their alerts. On devices that do not fully turn off, such as some Nokia smartphones, alerts will be triggered when they are supposed to.

FIG. 5 illustrates an instance where application is expanded into a larger system that helps compliance with taking medicines. In FIG. 5 a server component 31 synchronizes the user's schedule (within application of user's personal digital device 32) with a caregiver's device or computer 39. The synchronization can be set so that the caregiver creates the schedule, the user creates or edit it, or both. The server is accessed via existing Internet protocols. When the user's device 32 gives off an alert, either the user will acknowledge the alert (turn it off) 33 or not 34. Alternatively, the user's device will be off 36 and the alert will not be triggered at the correct time. When user acknowledges the alert 33 the application will automatically send a signal to the caregiver's device 39 that the alert was acknowledged. If the user does not acknowledge the alert within a pre-set amount of time, and the user's device is on 35, the application will look up its current GPS coordinates 37 and then will send a “not acknowledged” signal to the caregiver's device along with the GPS information. Caregiver's device 39 will initiate a series of steps 38 in order to find the user and tell him to take his medicine. If the user's device is off 36 the caregiver's device will know that it did not receive any type of signal from the user's device (due to the synchronization 31) and it will initiate a series of steps 38 in order to find the user and tell him to take his medicine. For example the caregiver's device 39 is a computer which automatically generates a voice message to the user's land-line telephone or an email to his computer as an advice to take his medicine when the user does not push the button on his cell phone to stop the timer's alert to take his medicine.

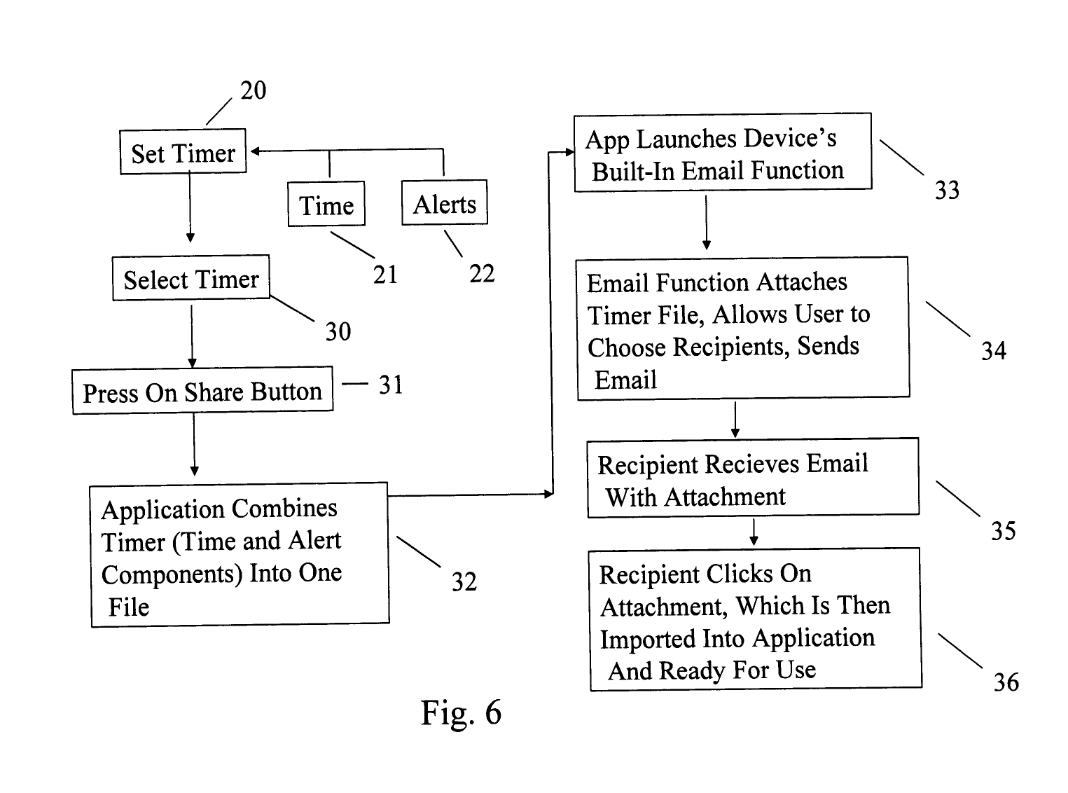

As shown in FIG. 6, a user can click on the ‘share alarm’ button in the app and it will package and then send the alarm/alerts to anyone in his/her email contact list. For example, if one sets a weekly piano lesson for his/her child, one can create the alarm for every Tuesday at 3 PM and add a photo of a piano, and record the users voice saying “piano lesson”. Then the user clicks on the share button and sends it via email to the child, who will open it on his/her device and import the alarm (time, photo, voice recording) into his/her copy of the application. By sharing via email, the application can be used and alarms/alerts can be shared by multiple people without the intervention of a central online service. The process, as shown in FIG. 6, would be that the user sets timer 20, including setting the time 21 and the alert 22. The user then selects timer 30 and presses the share button. Then the application, automatically will combine the time and alert components into one file 32. The application launches the device's built in email function, the user selects the email recipients and pushes the send button to send the email 34. The recipient receives the email 35 with the attachment. Then the recipient, if he/she wants the alert, will click on the attachment 36 and the recipient's application will automatically enter the time and alert on the recipient's personal digital device.

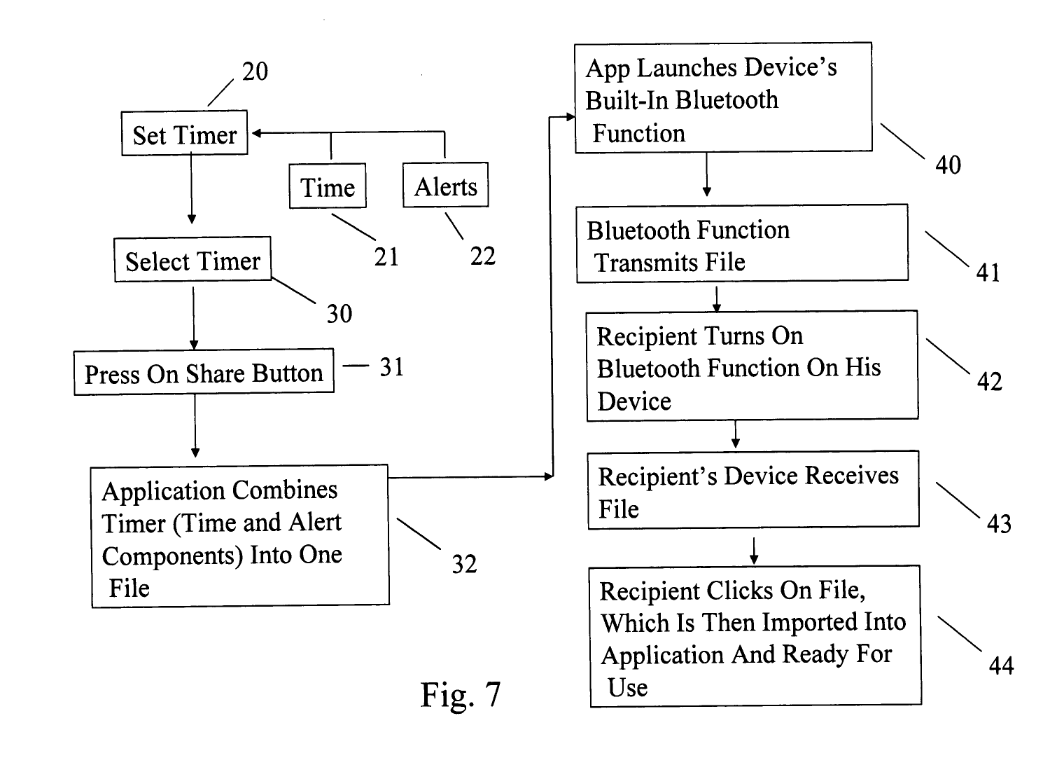

As shown in FIG. 7, a user can click on the ‘share alarm’ button in the app and it will package and then send the alarm/alerts to anyone within bluetooth proximity. For example, if one sets a weekly piano lesson for his/her child, one can create the alarm for every Tuesday at 3 PM and add a photo of a piano, and record the users voice saying “piano lesson”. Then the user clicks on the share button and transmits it to the child's device, which will open it and import the alarm (time, photo, voice recording) into his/her copy of the application. By sharing via bluetooth, the application can be used and alarms/alerts can be shared by people who are in close proximity to one another, for example business people arranging a meeting time, and without the intervention of a central online service or the need to go online to use email. The process, as shown in FIG. 7, would be that the user sets timer 20, including setting the time 21 and the alert 22. The user then selects timer 30 and presses the share button. Then the application will automatically combine the time and alert components into one file 32. The application launches the device's built-in bluetooth transmitter 40 and the device transmits the file 41. The recipient simultaneously activates the bluetooth function on his device 42 and recieves the file 43. Recipient then clicks on file 44, which is automatically imported into the application.

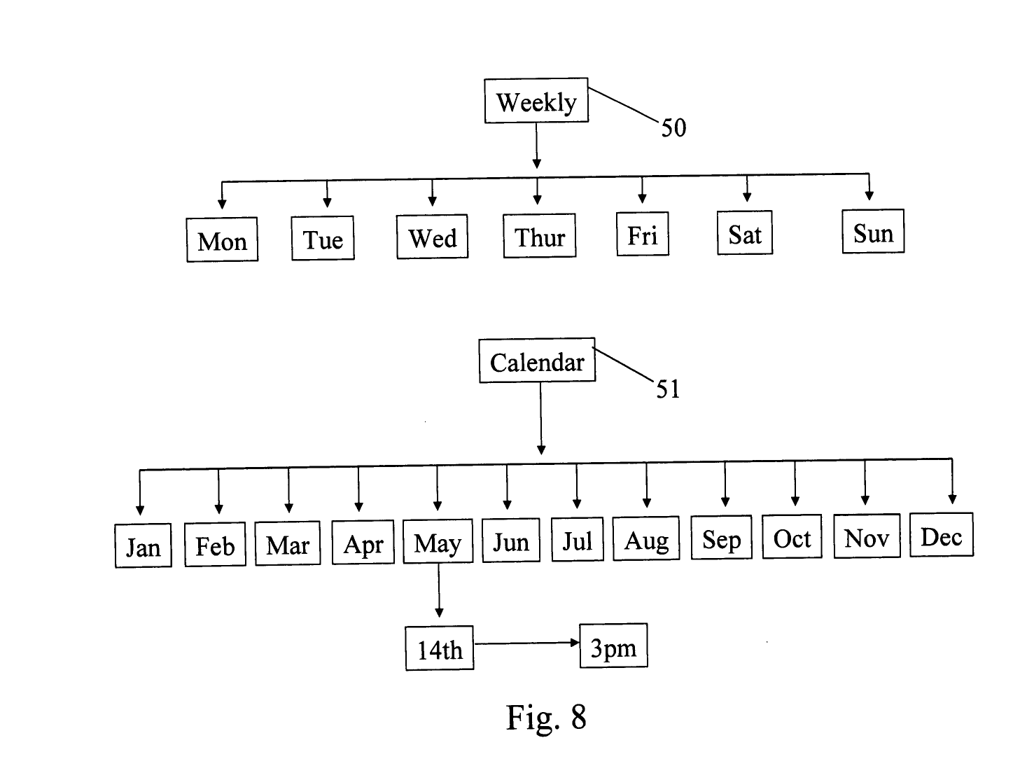

As shown in FIG. 8, a weekly alarm 50 is important to the countdown timer. A calendar function 51, is also important and is included in the application. A weekly alarm is good for events up one one week from now, but the calendar function extends to the indefinite future. For example, the weekly alarm may be set to set off an alarm on Tuesday and Saturday at 3 pm. The calender alarm may be set to activate an alarm on May 14 at 3 pm.

1. A computer software program having a plurality of timers that runs as a count down multi-timer application on a personal digital device (a hand held device which is battery operated, portable, has a digital display screen and is controlled by programmable digital software programs); wherein the timers are selected from the group of
(a) the timers are able to be pre-set to run in parallel, so that they have varying start times but all reach zero and give alerts at the same time;
(b) the timers are able to be pre-set to run serially, so that the end of one timer triggers another one to begin;
(c) the timers are able to be pre-set to run serially, so that the end of one timer notifies user to start the next one;
(d) a timer is able to be be set to repeat itself indefinitely, so that upon reaching zero and giving an alert to a user it begins counting down to zero again.

2. A computer software program as in claim 1 and having a plurality of means giving an alert to a user when the time has ended and the timer(s) have reached zero the various alerts are pre-set by a user
when setting up the timer; the means being selected from the group of:
(a) the alert is a spoken message that the user has recorded on the device;
(b) the alert is the display of a photo on the device;
(c) the alert is the playing of a video on the device;
(d) the alert is the playing of music on the device;
(e) the alert is the display of a text message on the device;

3. A computer software program as in claim 1 and having means of setting up timers selected from the group of;
(a) means to download alerts (pre-recorded sounds, images, video, text messages) from an online service. and (b) means to upload alerts to an online service for the purpose of sharing them with other users of the online service.

4. A computer software program as in claim 1 and having means for setting text or spoken alerts; selected from the group of;
(a) user speaks his alert, and means in the device for translating that spoken alert into the text message by using device's built-in speech to text technology;
(b) means in the device for contacting an online service to upload/download said spoken alert (
c) user types his alert into a text message, and means in the device for translating that text message
into a spoken message using device's built-in text to speech technology;
(d) means in the device for contacting an online service to upload and download the text message and spoken message.

5. A computer software program as in claim 1 and having a plurality of means for triggering timers to begin counting down, based on the sensors included within the device; selected from the group of;
(a) means for triggering a timer based on location, using the device's built-in location awareness sensor(GPS or A-GPS);
(b) means for triggering a timer based on temperature, using the device's built-in thermometer;
(c) means for triggering timer based on ambient noise, using the device's built-in microphone.

6. A method using an application installed on a personal digital device (a hand held device which is
battery operated, portable, has a digital display screen and is controlled by programmable digital software programs) including the steps of:
(a) recording a user's voice as an audio file as an alert for the end zero point of a timer run on the application; and
(b) the speaker of the device broadcasts the voice when the timer reaches said end zero point

7. A method using an application installed on a personal digital device (a hand held device which is battery operated, portable, has a digital display screen and is controlled by programmable digital software programs); wherein the digital device has a keyboard, display, and memory; including the steps of
(a) generating a text message using said keyboard;
(b) storing said text message in the device memory;
(c) at the end zero point of a timer, displaying said text message on the device display as an alert; and
(d) storing said text message in device memory, after the alert, for possible future alerts.

8. A method using an application installed on a personal digital device (a hand held device which is battery operated, portable, has a digital display screen and is controlled by programmable digital software programs), wherein the device has a built-in camera, a digital memory and a digital display screen; including the steps selected from the group of:
(a) taking a photograph and associating in device memory the photograph with a timer that is set up by a user and when the timer reached zero, displaying the photograph on the screen; and
(b) taking a video and associating in device memory the video with a timer that is set up by a user and when the timer reached zero, displaying the video on the screen.

9. A method using an application installed on a personal digital device (a hand held device which is battery operated, portable, has a digital display screen and is controlled by programmable digital software programs) including the steps of:
(a) recording an alert for the end zero point of a timer run on the application;
(b) by operation of a control, sending the timing of the alert and the alert by email to a second personal digital device; and
(c) entering the the timing of the alert and the alert into an application installed on the second personal digital device.

10. A method using an application installed on a personal digital device (a hand held device which is battery operated, portable, has a digital display screen and is controlled by programmable digital software programs) including the steps of:
(a) recording an alert for the end zero point of a timer run on the application;
(b) by operation of a control, sending the timing of the alert and the alert by bluetooth to a second personal digital device; and
(c) entering the the timing of the alert and the alert into an application installed on the second personal digital device.

11. A method as in claim 6 wherein the alert for the end zero point of the timer run on the application is set by the user's selection of a future date selected from a calender of the device and a future time on the selected date.

12. A method as in claim 7 wherein the alert for the end zero point of the timer run on the application is set by the user's selection of a future date selected from a calender of the device and a future time on the selected date.

13. A method as in claim 8 wherein the alert for the end zero point of the timer run on the application is set by the user's selection of a future date selected from a calender of the device and a future time on the selected date.
